(19) United States
(12) Patent Application Publication
(10) Pub. No.: US 2019/0248172 A1
(43) Pub. Date: Aug. 15, 2019

(54) BEACH WRITING UTENSIL

(71) Applicant: BeachLines LLC, Ocean Isle Beach, NC (US)

(72) Inventor: Robin Desjarlais, Calabash, NC (US)

(73) Assignee: BeachLines LLC, Ocean Isle Beach, NC (US)

(21) Appl. No.: 15/897,291

(22) Filed: Feb. 15, 2018

(51) Int. Cl. B43K 19/00

(52) U.S. Cl. CPC B43K 19/00

(57) ABSTRACT

A beach writing utensil includes an elongate body including a first half operatively coupled to a second half at a joint. A head is provided at a first end of the elongate body and defines a conical structure that tapers to a point. A tail is provided at a second end of the elongate body and a handle that extends between the head and the tail. An inner chamber is defined within the elongate body.

### BACKGROUND

During time spent at a beach location, it is not uncommon for an individual (a “beachgoer”) to carve into the hard-packed sand adjacent the waterfront to create a brief message, a design, or an illustration. The carving may not last long before being washed away by the rolling tide or other erosive conditions, but can have sentimental or entertainment value while temporarily etched into the sand. Oftentimes, the beach carving is photographed before it is washed away and sent to a family member, friend, acquaintance, etc.

To carve into the sand, beachgoers commonly use “natural” writing utensils found at or near the waterfront. Common natural writing utensils include sticks, driftwood, shells, or other debris that wash up on the beach. Finding a suitable natural writing utensil, however, is sometimes challenging. For example, the scarcity of natural writing utensils can be problematic and, when one is successfully found, it is often fragile and breaks easily. Moreover, finding an appropriately sized and ergonomic natural writing utensil at the beach can be difficult. If the natural writing utensil has an irregular shape (e.g., a blunt end), is too heavy, or is too large (e.g., diameter or length), it cannot be properly or comfortably gripped or handled. Furthermore, natural writing utensils are often dirty or covered in slimy sea film that makes gripping the natural writing utensil difficult and otherwise undesirable.

Accordingly, there remains heretofore a need for a beach writing utensil that overcomes the aforementioned issues.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a side view of an example beach writing utensil.

FIG. 2 is an exploded isometric view of the beach writing utensil of FIG. 1.

FIG. 3 is a cross-sectional side view of the beach writing utensil of FIG. 1 as assembled.

FIG. 4 is a side view of another example beach writing utensil.

FIG. 5 is an isometric side view of another example beach writing utensil.

FIG. 6 is a cross-sectional side view of the beach writing utensil of FIG. 5.

FIG. 7 is a another cross-sectional side view of the beach writing utensil of FIG. 5.

### DETAILED DESCRIPTION

The present disclosure is related to beach apparatus and, more particularly, to ergonomic beach writing utensils.

The present disclosure describes beach writing utensils used to create markings in the sand at a beach location. One example beach writing utensil includes an elongate body having a first half operatively coupled to a second half at a joint. A head may be provided at a first end of the elongate body and defines a conical structure that tapers to a point. A tail may be provided at a second end of the elongate body, and a handle may extend between the head and the tail. An inner chamber may be defined within the elongate body and may be sized to receive at least one article therein.

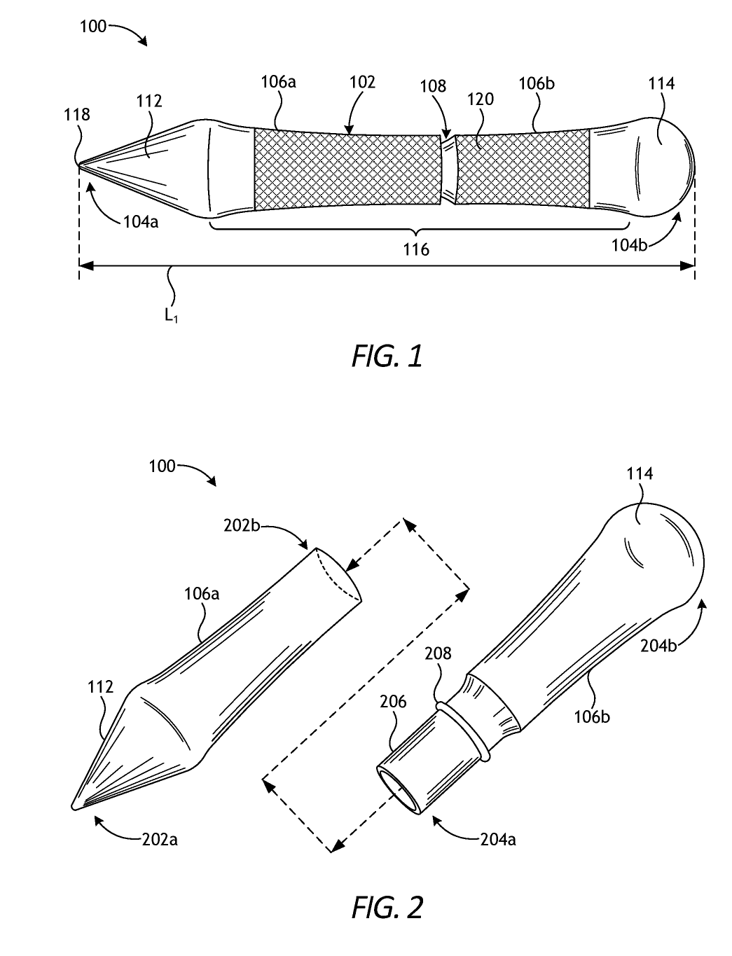

FIG. 1 is a side view of an example beach writing utensil 100 (alternately referred to as a “beach pen”), according to one or more embodiments of the present disclosure. The beach writing utensil 100 (hereafter “the utensil 100”) may generally be used to create depressions or markings in the sand (e.g., hard-packed or loose-packed sand) at a beach location adjacent the waterfront. While referred to herein as a “writing” utensil, the markings generated by the utensil 100 are not limited to lettering or textual carvings. Rather, the utensil 100 may also be used to carve any type of design, illustration, or image in the sand, without departing from the scope of the disclosure.

As illustrated, the utensil 100 comprises an elongate body 102 having a first end 104a and a second end 104b opposite the first end 104a. The body 102 may comprise a generally cylindrical structure that exhibits an overall assembled length L₁ that extends between the first and second ends 104a,b. The length L₁ of the utensil 100 may range between about five inches and about fifteen inches. In other embodiments, however, the length L₁ may be less than five inches or greater than fifteen inches, without departing from the scope of the disclosure. In general, the length L₁ may depend on the application. In some embodiments, for example, the utensil 100 may be used by an individual sitting down and, in such embodiments, the length L₁ may be smaller. In other embodiments, however, the utensil 100 may be used by an individual standing up and, in such embodiments, the length L₁ may larger. Moreover, it is contemplated herein to hang a smaller version of the utensil 100 on a keychain. In such embodiments, the utensil may have a length of about three inches or less, without departing from the scope of the disclosure.

In some embodiments, the body 102 may comprise an elongate, unbroken or continuous member extending between the first and second ends 104a,b. In other embodiments, however, the body 102 may be made up of two or more component parts, such as a first half 106a and a second half 106b. It is noted that the first and second halves 106a,b need not encompass equal half-lengths of the overall assembled length L₁ of the body 102. Rather, each half 106a,b may exhibit a different or discrete length, without departing from the scope of the disclosure. Accordingly, the term “half” as used in conjunction with the first and second halves 106a,b may be replaced with the terms “portion” or “member.” In at least one embodiment, however, the first and second halves 106a,b may have the same length.

The first and second halves 106a,b may be operatively coupled (either directly or indirectly) at a joint 108. As described herein, the joint 108 may encompass a variety of attachment means configured to couple the first half 106a to the second half 106b, and thereby form the utensil 100. In some embodiments, the joint 108 may comprise a removable (detachable) coupling engagement, where the first and second halves 106a,b are able to be manually separated when desired. In such embodiments, the utensil 100 may be conveniently stored as first and second halves 106a,b and may be easily assembled when it is desired to use the utensil 100. Following usage, the utensil 100 may be manually disassembled by separating the first and second halves 106a,b once again.

In other embodiments, however, the joint 108 may comprise a permanent coupling engagement, where the first and second halves 106a,b are permanently secured together. In such embodiments, the first and second halves 106a,b may be permanently attached at the joint 108 with, but not limited to, an epoxy (or another type of adhesive), a sonic weld, a friction stir weld, an interference fit, a shrink fit, or any combination thereof.

In some embodiments, the joint 108 may provide a flush or continuous transition between the first and second halves 106a,b. In other embodiments, however, the joint 108 may provide or otherwise define an annular groove 110 that extends about the outer circumference of the body 102. In at least one embodiment, the annular groove 110 may prove advantageous in providing an uneven gripping interface that may help a user grasp the utensil 100.

The body 102 may be made of a variety of rigid or semi-rigid materials including, but not limited to, a thermoplastic, a metal (e.g., aluminum, stainless steel, titanium, copper, etc.), ceramic, wood, a composite material (e.g., fiberglass, carbon fiber reinforced polymer, etc.), rubber (e.g., ebonite), an epoxy, or any combination thereof. In at least one embodiment, the material may be made of or include a phosphorescent material, such as zinc sulfide or strontium aluminate. In such embodiments, the body 102 may serve as a type of glow stick that can be used at night.

The first and second halves 106a,b may be made of the same material, but could alternatively be made of dissimilar materials, without departing from the scope of the disclosure. The body 102 may be manufactured via several different manufacturing processes including, but not limited to, molding, injection molding, machining, casting, additive manufacturing (e.g., 3-dimensional printing), or any combination thereof.

As illustrated, the utensil 100 includes a head 112, a tail 114, and a handle 116 that interposes or otherwise extends between the head and the tail 114. The head 112 is provided at the first end 104a and provides or otherwise defines a generally conical structure that tapers (continuously or non-continuously) to a point 118. The head 112 may be used to engage and carve markings into the sand during use. In some embodiments, the outer surface of the conical structure may be smooth. In other embodiments, however, the conical structure may comprise a pyramid having a plurality of planar surfaces extending from a polygonal base and converging at the point 118.

The tail 114 is provided at the second end 104b. In some embodiments, the tail 114 may comprise a generally bulbous member. In other embodiments, however, the tail 114 may exhibit similar geometry as the handle 116.

The handle 116 provides a location along the body 102 where a user may grasp the utensil 100 for use. In some embodiments, the handle 116 may provide a smooth or semi-smooth outer surface. In other embodiments, however, the handle 116 may include or otherwise provide a gripping interface 120 configured to aid a user in grasping the utensil 100. In some embodiments, as illustrated, the gripping interface 120 may comprise an uneven, knurled, or textured surface defined on the outer surface of the handle 116. In other embodiments, however, the gripping interface 120 may comprise a grip or grip structure (not shown) molded or overmolded onto the outer surface of the handle 116. In such embodiments, the grip structure may be made of, for example, an elastomer or a soft plastic and may provide comfort and/or an ergonomic fit for the user.

As indicated above, the utensil 100 may be used to carve markings into the sand (e.g., hard-packed or loose-packed sand) at a beach location adjacent the waterfront. In example use, a user may grasp the utensil 100 at the handle 116 with a hand. The user may then direct the head 112 into engagement with the sand and manipulate the orientation of the tip 118 to inscribe whatever design, lettering, or illustration the user desires.

FIG. 2 is an exploded isometric view of the utensil 100. As illustrated, the first half 106a provides opposed first and second ends 202a and 202b, and the second half 106b provides opposed first and second ends 204a and 204b. The head 112 is provided at the first end 202a of the first half 106a, and the tail 114 is provided at the second end 204b of the second half 106b.

The joint 108, as described above with reference to FIG. 1, encompasses the coupled engagement between the second end 202b of the first half 106a and the first end 204a of the second half 106b. In some embodiments, a reduced-diameter member 206 may be provided at the first end 204a of the second half 106b and may be sized and otherwise configured to be received within the second end 202b of the first half 106a at the first end 202a. The reduced-diameter member 206 may be received within the first half 106a and suitably secured thereto via a variety of means including, but not limited to, an interference fit, a shrink fit, a snap-fit engagement, a threaded engagement, one or more mechanical fasteners (e.g., bolts, screws, pins, etc.), a spring-loaded bayonet connection, a magnetic coupling, or any combination thereof.

The foregoing removable attachment means may allow a user to exchange or interchange the tip 112 with different styles, sizes, or configurations of tips. More specifically, since the tip 112 is included on the first half 106a, detaching the first half 106b from the second half 106b allows a user to replace the first half 106a with a different tip 112. In some cases, the tip 112 may become worn from prolonged usage, and the tip 112 may be replaced with a new tip, if desired.

In at least one embodiment, the interface between the first and second halves 106a,b may be sealed with one or more sealing elements 208 (one shown). In some embodiments, as illustrated, the sealing element 208 may be carried on the reduced diameter member 206. In other embodiments, the sealing element 208 may be arranged within the interior 210 of the first half 106a, or a combination of both. The sealing element 208 may comprise, for example, an annular ring of elastomeric material, such as an O-ring or the like.

As will be appreciated, sealing the interface between the first and second halves 106a,b may prove advantageous in isolating the interior of the utensil 100 and thereby preventing the ingress of water, sand, or other external contaminants. As a result, a user may be able to secure valuables or others items within the interior of the utensil 100 and protect such valuables from damage or disruption. Alternatively, sealing the interface between the first and second halves 106a,b may prove advantageous in preventing the egress of a fluid from the interior of the utensil 100. Consequently, the interior of the utensil 100 may be filled with a desired fluid, such as water that may be consumed.

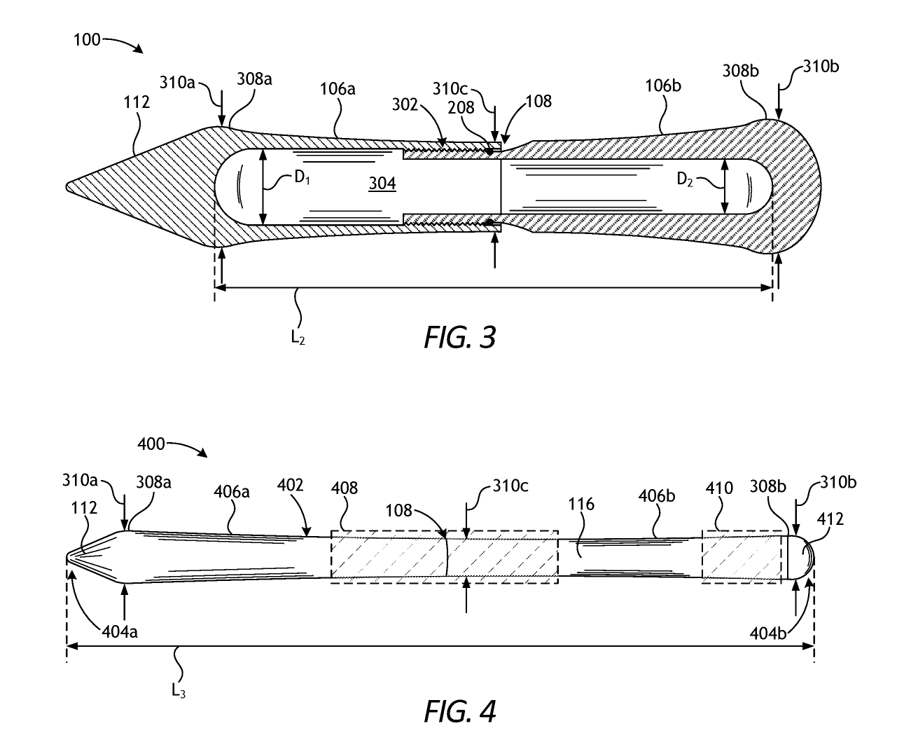

FIG. 3 is a cross-sectional side view of the utensil 100 as assembled, according to one or more embodiments. More specifically, FIG. 3 depicts the first half 106a operatively coupled to the second half 106b at the joint 108. In the illustrated embodiment, the joint 108 comprises a threaded interface 302, but could alternatively comprise any of the coupled engagements described herein. The sealing element 208 may also be included in the joint 108 to provide a sealed interface. As will be appreciated, however, the sealing element 208 may be omitted from the embodiment and the threaded interface 302 may alternatively provide an adequate sealed interface, without departing from the scope of the disclosure.

An inner chamber 304 may be defined within the body 102. In some embodiments, as illustrated, the inner chamber 304 may be cooperatively defined by both the first and second halves 106a,b, where corresponding interiors of each half 106a,b overlap with each other at the location of the joint 108. In the illustrated embodiment, the inner chamber 304 exhibits a length L₂ that extends into both halves 106a,b. In other embodiments, however, the inner chamber 304 may be defined within only one of the halves 106a,b. In such embodiments, the length L₂ of the inner chamber 304 would be constrained to only one of the halves 106a,b.

The inner chamber 304 may provide a secure and/or sealed location to store and protect various items from external contamination. The inner chamber 304 provides an inner diameter that may vary depending on the size of the utensil 100. In the illustrated embodiment, the inner chamber 304 exhibits a first inner diameter D₁ within the interior of the first half 106a and exhibit a second inner diameter D₂ within the interior of the second half 106b. The first inner diameter D₁ may be larger than the second inner diameter D₂, but may alternatively be the same or smaller than the second inner diameter D₂, without departing from the scope of the disclosure.

The inner diameters D₁, D₂ may be large enough to accommodate different types of items or articles within the inner chamber 304. Suitable articles that may be arranged within the inner chamber 304 include, but are not limited to, chap stick, sun block, money (e.g., rolled bills, coins, etc.), car keys, sand, sea shells, shark teeth (or other items found on the beach), candy, cigarettes, a glow stick, a flashlight, or any combination thereof. Moreover, since the inner chamber 304 may be sealed, the utensil 100 may be able to float, which may prove advantageous at a beach location in the event the utensil 100 is inadvertently placed in the water.

The head 112 transitions to the handle 116 at a head transition location 308a that exhibits a first outer diameter 310a, and the tail 114 transitions to the handle 116 at a tail transition location 308b that exhibits a second outer diameter 310b. At its smallest location, the handle 116 exhibits a third outer diameter 310c. In some embodiments, as illustrated, the first and second outer diameters 310a,b are larger than the third outer diameter 310c. Accordingly, the handle 116 may taper from the head and tail transition locations 308a,b to a smaller diameter, which may prove advantageous in providing the user with a more ergonomic grasping location for the utensil 100. In some embodiments, the first and second outer diameters 310a,b may be the same, but may alternatively be different in magnitude, without departing from the scope of the disclosure.

In some embodiments, it may prove advantageous to have a larger first outer diameter 310a to provide a user with a more robust head 112 for use. More specifically, the head 112 may be required to be more robust since, depending on how the user grips the utensil 100, the head 112 will typically assume the majority of bending loads assumed by the utensil 100 during use. If the first outer diameter 310a were smaller than the third outer diameter 310c, the utensil 100 may be more prone to breakage at or near the head 112 during use.

Moreover, the larger second outer diameter 310b may prove advantageous in making it difficult for a user's hand to slip off the handle and past the tail 114 during use. The larger first and second outer diameters 310a,b may also help a user hold a larger or longer utensil 100. Lastly, a smaller third outer diameter 310c may provide a more ergonomic gripping location for the user. If the third outer diameter were larger than the first outer diameter 310a, for example, the gripping location may be too large to comfortably wield.

FIG. 4 is a side view of another example beach writing utensil 400, according to one or more embodiments of the present disclosure. The beach writing utensil 400 (hereafter “the utensil 400”) may be similar in some respects to the utensil 100 of FIGS. 1-3 and therefore may be best understood with reference thereto, where like numerals will correspond to like components not described again in detail. Similar to the utensil 100 of FIGS. 1-3, for example, the utensil 400 includes an elongate body 402 having opposing first and second ends 404a and 404b. The body 402 may comprise a generally cylindrical structure made of any of the materials mentioned herein for the body 102 (FIG. 1), and may be manufactured via any of the associated manufacturing processes. Moreover, the body 402 may have an overall assembled length L₃, which may be larger (longer) than the length L₁ of FIG. 1, but could alternatively be the same or smaller (shorter), without departing from the scope of the disclosure.

Furthermore, similar to the utensil 100 of FIGS. 1-3, the utensil 400 includes first and second halves 406a and 406b, but could alternatively comprise an elongate, unbroken or continuous member. The first and second halves 406a,b may be operatively coupled (either directly or indirectly) at the joint 108, which may comprise any of the permanent or removable attachment means described herein. In the illustrated embodiment, the joint 108 may comprise a welded interface, where the respective ends of the first and second halves 406a,b are secured together via a butt-joint attachment (e.g., a sonic weld, friction stir weld, an adhesive, etc.). Moreover, in the illustrated embodiment, the joint 108 provides a flush or continuous transition between the first and second halves 406a,b.

Unlike the utensil 100 of FIGS. 1-3, the first outer diameter 310a at the head transition location 308a may be greater than the second outer diameter 310b at the tail transition location 308b, and the second outer diameter 310b may be greater than the third outer diameter 310c at the handle 116. In other embodiments, however, the second and third outer diameters 310b,c may be similar and both smaller than the first outer diameter 310a, without departing from the scope of the disclosure.

The utensil 400 may also include a grip 408 (shown in phantom). The grip 408 may comprise a separate structure positioned on the handle 116 to help a user ergonomically and/or securely grasp the utensil 400 for use. The grip 408 may extend partially or entirely about the outer circumference of the handle 116. In some embodiments, the grip 408 may be molded or overmolded onto the outer surface of the handle 116. In such embodiments, the grip 408 may be made an elastomer, a soft plastic, or another type comfortable material.

In at least one embodiment, the utensil 400 may also include a second grip 410 (also shown in phantom) axially offset from the first grip 408. As illustrated, the first grip 408 may be positioned at or near an intermediate location along the length L₃ of the utensil. In contrast, the second grip 410 may be positioned at or near the second end 404b. The second grip 410 may prove advantageous in allowing a user to grasp the utensil 400 with two hands, and thereby gain a mechanical advantage or leverage while carving into the sand.

The body 402 may be solid or hollow. In embodiments where the body 403 is hollow, the body 402 may define an inner chamber similar to the inner chamber 304 of FIG. 3. The inner chamber of the body 402 may be used to store and protect various items from external contamination. In some embodiments, the body 402 may include a cap 412 at the second end 404b, and the cap 412 may be removable (e.g., threaded) to access the inner chamber. Moreover, the cap 412 may provide a sealed interface that prevents the ingress or egress of fluids. In such embodiments, the inner chamber may be filled with a liquid, such as water or any other type of liquid that may be consumed by the user.

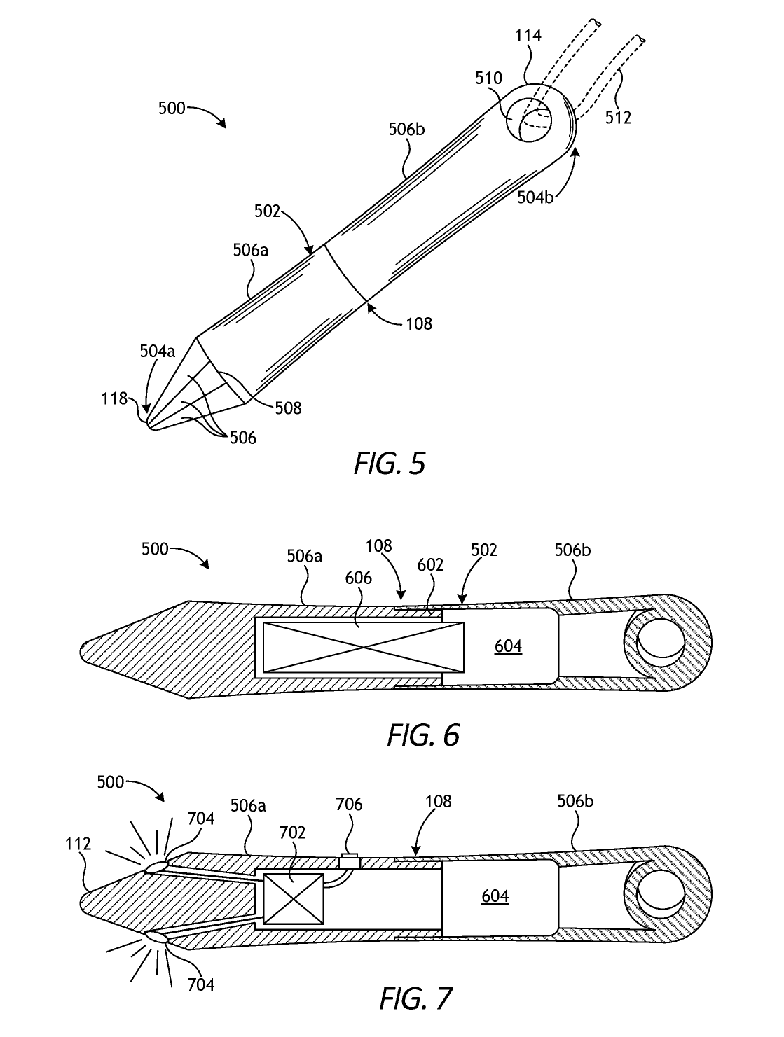

FIG. 5 is an isometric side view of another example beach writing utensil 500, according to one or more embodiments of the present disclosure. The beach writing utensil 500 (hereafter “the utensil 500”) may be similar in some respects to the utensils 100 and 400 of FIGS. 1-3 and 4, respectively, and therefore may be best understood with reference thereto, where like numerals will correspond to like components not described again in detail.

Similar to the utensils 100 and 400, for example, the utensil 500 includes an elongate body 502 having opposing first and second ends 504a and 504b. The body 502 may comprise a generally cylindrical structure made of any of the materials mentioned herein for the body 102 (FIG. 1), and may be manufactured via any of the associated manufacturing processes. Furthermore, similar to the utensil 100 of FIGS. 1-3, the utensil 500 can include first and second halves 506a and 506b, but could alternatively comprise an elongate, unbroken or continuous member. The first and second halves 406a,b may be operatively coupled (either directly or indirectly) at the joint 108, which may comprise any of the permanent or removable attachment means described herein.

Unlike the utensils 100 and 400 of FIGS. 1-3 and 4, respectively, however, the conical structure of the head 112 comprises a pyramid having a plurality of planar surfaces 506 extending from a polygonal base 508 and converging at the point 118. The sharp corners or lines that provide the transition between angularly adjacent planar surfaces 506 may prove advantageous in providing a sharper or more refined carving instrument. Moreover, the harder a user pushes down in the sand with the utensil 500, the wider or bolder the strokes will be and will generate lines with dimension.

Moreover, an aperture 510 may be defined in the tail 114 at the second end 504b. The aperture 510 may be used for a variety of purposes. In some embodiments, for example, the aperture 510 may provide a location to attach an elongate member 512 (shown in dashed) to the utensil 500. The elongate member 512 can include, but is not limited to, a string, a wire, a cord, a cable, a rope, or any combination thereof. The elongate member 512 may be used to secure the utensil 500 to another member or structure, such as a keychain, a bag, a beach chair, a beach tent or shelter, etc. When it is desired to use the utensil 500, the elongate member may be untied or detached from either the aperture 510 or the other member or structure. In at least one embodiment, the elongate member 512 may serve as a necklace that allows the user to wear the utensil 500 around the neck. When it is desired to use the utensil 500, the necklace may simply be removed from the user's neck.

FIG. 6 is a cross-sectional side view of the utensil 500, according to one or more embodiments. More specifically, FIG. 6 depicts the first half 506a operatively coupled to the second half 506b at the joint 108, where a reduced diameter portion 602 of the first half 506a is received within the second half 506b. In the illustrated embodiment, the joint 108 may comprise an interference fit that may be separated by pulling on each half 506a,b in opposite directions.

An inner chamber 604 may be defined within the body 502. In some embodiments, as illustrated, the inner chamber 604 may be cooperatively defined by both the first and second halves 506a,b, where corresponding interiors of each half 506a,b overlap with each other at the location of the joint 108. The inner chamber 604 may provide a secure and/or sealed location to store and protect at least one article 606 from external contamination. Suitable articles 606 that may be arranged within the inner chamber 604 include any of those mentioned above with respect to the chamber 304 of FIG. 3.

FIG. 7 is a cross-sectional side view of another embodiment of the utensil 500, according to one or more additional embodiments. In FIG. 7, the utensil 500 may also be used as a flashlight or light source. More specifically, a power source 702 may be arranged within the inner chamber 604 and may be electrically coupled to one or more lights 704 (two shown). The power source 702 may comprise, for example, one or more disposable or rechargeable batteries. The lights 704 may comprise any type of electrically powered light source such as, but not limited to, incandescent light bulbs or light emitting diodes. In some embodiments, a button 706 may be secured to the body 502 and electrically coupled to the power source 702 and the lights 704 to regulate operation thereof. In other embodiments, however, the button 706 may be omitted, and the lights 704 may instead be turned on by rotating the first half 506a relative to the second half 506b at the joint 108.

In the illustrated embodiment, the lights 704 are depicted as being located on the head 112 of the utensil 500. In such embodiments, the lights 704 may comprise or otherwise be covered with a scratch resistant material such that the surfaces of the lights 704 are not be marred as the tip 112 of the utensil 500 is used to make markings in the sand. In other embodiments, however, the lights 704 may be positioned at any other location along the length of the body 502, without departing from the scope of the disclosure.

The lights 704 (and the button 706, if used) may also provide a fluid tight fitting or engagement against the body 502. Consequently, the utensil 500 may alternatively be used as a water toy, such as a pool toy that lights up.

Embodiments disclosed herein include:

A. A beach writing utensil that includes an elongate body including a first half operatively coupled to a second half at a joint, a head provided at a first end of the elongate body and defining a conical structure that tapers to a point, a tail provided at a second end of the elongate body, a handle that extends between the head and the tail, and an inner chamber defined within the elongate body.

B. A beach writing utensil that includes an elongate body having a first end and a second end opposite the first end, a head provided at the first end and defining a conical structure that tapers to a point, wherein the head exhibits a first outer diameter, a tail provided at the second end and exhibiting a second outer diameter, and a handle that extends between the head and the tail and exhibits a third outer diameter, wherein the first and second outer diameters are each greater than the third outer diameter.

Each of embodiments A and B may have one or more of the following additional elements in any combination: Element 1: wherein the first and second halves are manually separable at the joint. Element 2: wherein the first and second halves are operatively coupled at the joint via at least one of an interference fit, a shrink fit, a snap-fit engagement, a threaded engagement, one or more mechanical fasteners, a magnetic coupling, a spring-loaded bayonet connection, and any combination thereof. Element 3: wherein one of the first and second halves provides a reduced-diameter member that is receivable within the other of the first and second halves. Element 4: wherein the elongate body is made of a material selected from the group consisting of a thermoplastic, a metal, wood, a composite material, ceramic, rubber, an epoxy, a phosphorescent material, and any combination thereof. Element 5: wherein an outer surface of the handle defines a gripping interface comprising at least one of an uneven surface, a knurled surface, a textured surface, and any combination thereof. Element 6: wherein the joint comprises a sealed interface between the first and second halves. Element 7: further comprising one or more lights attached to the elongate body, and a power source arranged within the inner chamber and electrically coupled to the power source to provide electrical power to the one or more lights. Element 8: wherein the head exhibits a first outer diameter, the tail exhibits a second outer diameter, and the handle exhibits a third outer diameter, and wherein the first and second outer diameters are greater than the third outer diameter. Element 9: wherein the first outer diameter is greater than the second outer diameter. Element 10: wherein the first and second outer diameters are the same. Element 11: further comprising a grip arranged on the handle. Element 12: wherein the first and second halves are permanently attached at the joint. Element 13: wherein the first and second halves are permanently attached with at least one of an epoxy, a sonic weld, a friction stir weld, an interference fit, a shrink fit, and any combination thereof.

Element 14: wherein the elongate body comprises a first half operatively coupled to a second half at a joint. Element 15: wherein the first and second halves are manually separable at the joint. Element 16: further comprising an inner chamber defined within the elongate body. Element 17: further comprising a cap arranged at the second end and removable to access the inner chamber, wherein the cap provides a sealed interface at the second end. Element 18: further comprising an aperture defined in the tail, and an elongate member attachable to the elongate body at the aperture.

By way of non-limiting example, exemplary combinations applicable to A and B include: Element 1 with Element 2; Element 8 with Element 9; Element 8 with Element 10; Element 12 with Element 13; Element 14 with Element 15; and Element 16 with Element 17.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A beach writing utensil, comprising:
an elongate body including a first half operatively coupled to a second half at a joint;
a head provided at a first end of the elongate body and defining a conical structure that tapers to a point;
a tail provided at a second end of the elongate body;
a handle that extends between the head and the tail; and
an inner chamber defined within the elongate body.

2. The beach writing utensil of claim 1, wherein the first and second halves are manually separable at the joint.

3. The beach writing utensil of claim 2, wherein the first and second halves are operatively coupled at the joint via at least one of an interference fit, a shrink fit, a snap-fit engagement, a threaded engagement, one or more mechanical fasteners, a magnetic coupling, a spring-loaded bayonet connection, and any combination thereof.

4. The beach writing utensil of claim 1, wherein one of the first and second halves provides a reduced-diameter member that is receivable within the other of the first and second halves.

5. The beach writing utensil of claim 1, wherein the elongate body is made of a material selected from the group consisting of a thermoplastic, a metal, wood, a composite material, ceramic, rubber, an epoxy, a phosphorescent material, and any combination thereof.

6. The beach writing utensil of claim 1, wherein an outer surface of the handle defines a gripping interface comprising at least one of an uneven surface, a knurled surface, a textured surface, and any combination thereof.

7. The beach writing utensil of claim 1, wherein the joint comprises a sealed interface between the first and second halves.

8. The beach writing utensil of claim 1, further comprising:
one or more lights attached to the elongate body; and
a power source arranged within the inner chamber and electrically coupled to the power source to provide electrical power to the one or more lights.

9. The beach writing utensil of claim 1, wherein the head exhibits a first outer diameter, the tail exhibits a second outer diameter, and the handle exhibits a third outer diameter, and wherein the first and second outer diameters are greater than the third outer diameter.

10. The beach writing utensil of claim 9, wherein the first outer diameter is greater than the second outer diameter.

11. The beach writing utensil of claim 9, wherein the first and second outer diameters are the same.

12. The beach writing utensil of claim 1, further comprising a grip arranged on the handle.

13. The beach writing utensil of claim 1, wherein the first and second halves are permanently attached at the joint.

14. The beach writing utensil of claim 13, wherein the first and second halves are permanently attached with at least one of an epoxy, a sonic weld, a friction stir weld, an interference fit, a shrink fit, and any combination thereof.

15. A beach writing utensil, comprising:
an elongate body having a first end and a second end opposite the first end;
a head provided at the first end and defining a conical structure that tapers to a point, wherein the head exhibits a first outer diameter;
a tail provided at the second end and exhibiting a second outer diameter; and
a handle that extends between the head and the tail and exhibits a third outer diameter, wherein the first and second outer diameters are each greater than the third outer diameter.

16. The beach writing utensil of claim 15, wherein the elongate body comprises a first half operatively coupled to a second half at a joint.

17. The beach writing utensil of claim 16, wherein the first and second halves are manually separable at the joint.

18. The beach writing utensil of claim 15, further comprising an inner chamber defined within the elongate body.

19. The beach writing utensil of claim 18, further comprising a cap arranged at the second end and removable to access the inner chamber, wherein the cap provides a sealed interface at the second end.

20. The beach writing utensil of claim 15, further comprising:
an aperture defined in the tail; and
an elongate member attachable to the elongate body at the aperture.
